(19) United States
(12) Patent Application Publication
(10) Pub. No.: US 2004/0168162 A1
(43) Pub. Date: Aug. 26, 2004

(54) System and method for shortening compiling time of byte codes in java program

(75) Inventors: Junggyu Park, Seoul (KR); Hyojung Song, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 10/730,046

(22) Filed: Dec. 9, 2003

(30) Foreign Application Priority Data
Feb. 24, 2003 (KR) 10-2003-0011366

(51) Int. Cl. G06F 9/45

(52) U.S. Cl. 717/166; 717/148; 717/151

(57) ABSTRACT

A system and method are provided in which relevant byte codes that are frequently used upon execution of a Java program are compiled to corresponding native codes and the resultant native codes are stored so that the native codes for the relevant byte codes are retrieved and executed upon future execution of the Java program, thereby shortening the time required for generating the native codes by compiling the byte codes.

This application claims the priority of Korean Patent Application No. 10-2003-0011366 filed on Feb. 24, 2003, in the Korean Intellectual Property Office, the disclosure of which is incorporated herein in its entirety by reference.

### BACKGROUND OF THE INVENTION

1. Field of Invention

The present invention relates to a system and method for shortening the compiling time of byte codes in a Java program, and more particularly, to a system and method for shortening the compiling time of byte codes in a Java program, wherein byte codes frequently used upon execution of the Java program are compiled and resultant native codes are retrieved and executed upon future execution of the Java program, thereby shortening the compiling time of the native codes.

2. Description of the Related Art

Generally, byte codes generated through a compiling process of Java program source codes are executed by a Java virtual machine (JVM). Recently, in order to enhance the execution speed of the Java virtual machine, methods in which a CPU interprets byte codes to directly executable native codes have been widely used.

Among such methods, in the dynamic adaptive compilation (DAC), byte codes are interpreted and those that are categorized as bottleneck byte codes, which are frequently used byte codes, are compiled to native codes to be executed. That is, the DAC method compiles only frequently used byte codes to native codes, rather than all the byte codes in a program.

However, there are problems in that the native codes generated during the execution of the byte codes are collected by a garbage collector, in case of lack of memory, and cannot be reused for future execution since all native codes are deleted after the Java program has been completely executed.

Since most of the byte codes that have once been compiled to native codes tend to be repeatedly compiled for future execution, there is a problem in that the deletion of the generated native codes results in the repeated generation of the same native codes to be used in future executions. Thus, the conventional methods have problems in that in a system such as a mobile terminal with a low-performance CPU and a low-capacity battery, system response time is increased and the battery is rapidly exhausted.

### SUMMARY

The present invention is conceived to solve the aforementioned problems. An exemplary object of the present invention is to provide a system and method for shortening the compiling time of byte codes in a Java program, wherein relevant byte codes frequently used upon execution of the Java program are compiled and resultant native codes are stored so that the native codes for the relevant byte codes are retrieved and executed upon future execution of the Java program.

Another exemplary object of the present invention is to provide a system and method for shortening the compiling time of byte codes in a Java program, by which the compiling time and the execution time of the Java program are shortened in equipment with a low-performance CPU and a low-capacity battery, thereby reducing response time to a user and conserving battery power.

According to an exemplary aspect of the present invention for achieving these objects, there is provided a system for shortening the compiling time of byte codes in a Java program, comprising a class loader unit for loading byte codes generated by compiling Java program source codes; a first memory unit for maintaining the byte codes loaded by the class loader unit and native codes generated by compiling the byte codes in an accessible state; a second memory unit for storing the native codes that are loaded into the first memory unit in the accessible state; a native code manager unit for searching the native codes stored in the second memory unit and loading the searched native codes into the first memory unit according to a request by a class loader unit; and an execution unit for executing the native codes that are loaded into the first memory unit in the accessible state.

In addition, according to another exemplary aspect of the present invention, there is provided a method for shortening the compiling time of byte codes in a Java program, comprising the steps of loading compiled byte codes by a class loader unit; requesting a native code manager unit to search native codes corresponding to the loaded byte codes; searching the requested native codes in a second memory unit; transmitting the searched native codes to a first memory unit; and executing the transmitted native codes by a code execution unit.

### BRIEF DESCRIPTION OF THE DRAWINGS

The above and other objects and features of the present invention will become apparent from the following description of illustrative, non-limiting embodiments given in conjunction with the accompanying drawings, in which:

FIG. 1 is a block diagram schematically showing an exemplary system for shortening the compiling time of byte codes in a Java program; and

FIG. 2 is a flowchart schematically illustrating an exemplary method for shortening the compiling time of byte codes in a Java program.

### DESCRIPTION

Hereinafter, illustrative, non-limiting embodiments of the present invention will be described in detail with reference to the accompanying drawings.

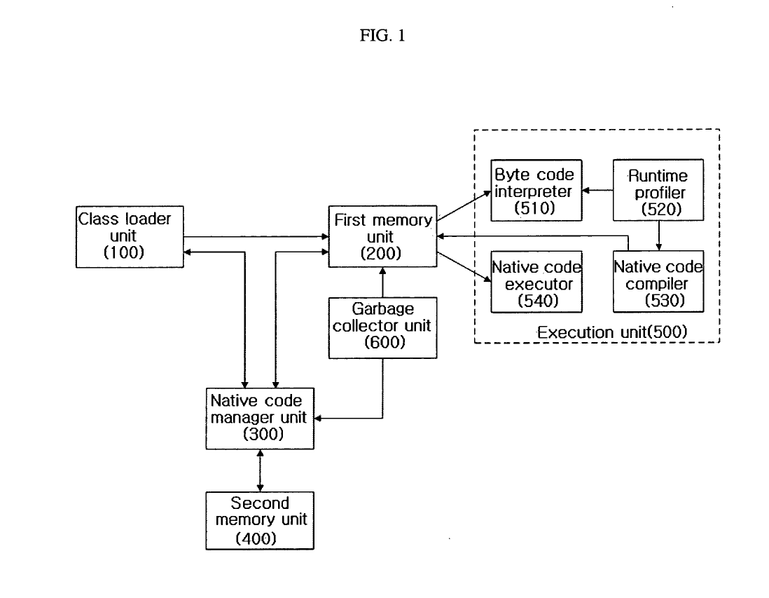

FIG. 1 is a block diagram schematically showing an exemplary system for shortening the compiling time of byte codes in a Java program. The system comprises a class loader unit 100, a first memory unit 200, a native code manager unit 300, a second memory unit 400, an execution unit 500 and a garbage collector unit 600.

The class loader unit 100 loads the byte codes generated by compiling Java program source codes. Here, the byte codes originally located in an auxiliary memory unit are loaded into a Java virtual machine.

The first memory unit 200 maintains the byte codes loaded by the class loader unit 100 and the native codes generated by compiling the byte codes in an accessible state. That is, the byte codes loaded by the class loader unit 100 and the native codes generated by compiling the byte codes are stored in predetermined memory areas so that the execution unit 500 to be described later can access the stored native codes.

The second memory unit 400 stores the native codes that are loaded into the first memory unit 200 in the accessible state.

The native code manager unit 300 stores the native codes, which have been loaded into the first memory unit 200, in the second memory unit 400.

The native code manager unit 300 searches the native codes stored in the second memory unit 400 according to a request by the class loader unit 100, and loads the searched native codes into the first memory unit 200. The native code manager unit 300 manages the native codes stored in the second memory unit 400 by using the least recently used (LRU) method. In the LRU method, rarely used native codes among the stored native codes are checked and then deleted in order of rarity of use thereof. Here, the rarely used native codes are deleted, for example, based on memory size and time when they were stored.

The execution unit 500 executes the native codes and byte codes loaded into the first memory unit 200 in the accessible state, and comprises a byte code interpreter 510, a runtime profiler 520, a native code compiler 530 and a native code executor 540.

The byte code interpreter 510 interprets the byte codes loaded into the first memory unit 200 in the accessible state and executes the interpreted byte codes.

The runtime profiler 520 checks whether the byte codes interpreted by the byte code interpreter 510 are frequently used byte codes and reports the check results to the native code compiler 530. The native code compiler 530 generates native codes by compiling the byte codes being interpreted. Further, the native code compiler 530 loads the compiled native codes into the first memory unit 200 if the runtime profiler 520 confirms that the byte codes are frequently used byte codes.

The native code executor 540 executes the native codes loaded into the first memory unit by the native code manager unit 300.

The garbage collector unit 600 automatically collects space occupied by unused codes in the first memory unit 200 so as to secure more space in the first memory unit 200. If a space shortage occurs in the first memory unit 200 even after the garbage collector unit 600 has collected the space occupied by the unused codes, the garbage collector unit 600 requests the native code manager unit 300 to store the native codes in the second memory unit 400.

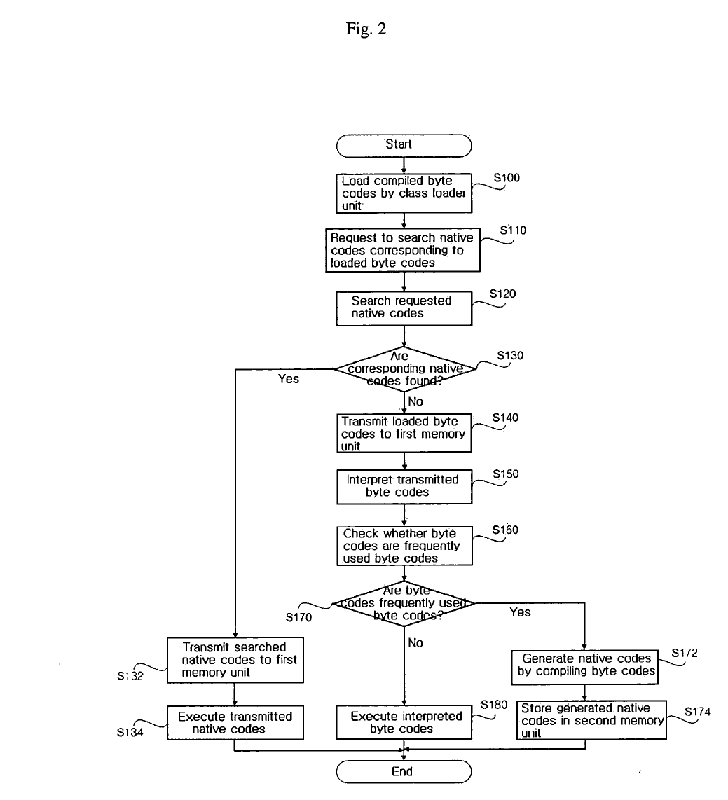

FIG. 2 is a flowchart schematically illustrating an exemplary method for shortening the compiling time of byte codes in a Java program according to the present invention.

First, the class loader unit 100 loads the byte codes generated by compiling Java program source codes (S100) and requests the native code manager unit 300 to search for native codes corresponding to the loaded byte codes (S110). Then, the native code manager unit 300 searches for the requested native codes in the second memory unit 400 (S120).

When the corresponding native codes are found in the second memory unit 400 (S130), the searched native codes are transmitted to the first memory unit 200 (S132). Then, the native code executor 540 executes the native codes transmitted to the first memory unit 200 (S134). Here, the native codes stored in the second memory unit 400 are native codes generated by compiling the frequently used byte codes in the Java program.

In the present invention, the native codes stored in the second memory unit 400 are simply loaded into and executed in the first memory unit. Thus, there is an advantage in that it is not necessary to interpret the frequently used byte codes every time, thereby eliminating the byte code interpretation process.

Meanwhile, if there are no native codes corresponding to the relevant byte codes as a result of the search of the second memory unit 400 by the native code manager unit 300, the class loader unit 100 transmits the loaded byte codes to the first memory unit 200 (S140).

When the byte codes are loaded into the first memory unit 200, the byte code interpreter 510 interprets the loaded byte codes to be executed (S150).

While the byte code interpreter 510 interprets the byte codes, the runtime profiler 520 checks whether the byte codes being interpreted are the frequently used byte codes (S160). The check results are then transmitted to the native code compiler 530.

If it is determined that the byte codes are frequently used byte codes as a result of the checking process (S170), the interpreted byte codes are transmitted to the native code compiler 530 and compiled to generate corresponding native codes (S172). Here, the native codes are transmitted to the first memory unit 200 and then stored in the second memory unit 400 by the native code manager unit 300 (S174). At this time, the native codes that are stored in the second memory unit 400 are managed by the native code manager unit 300 according to the LRU method. That is, since there are limitations in storage areas of the second memory unit 400, the LRU method is employed to manage the stored native codes.

However, byte codes that are not frequently used or are defined as having been previously unused, will be interpreted by the byte code interpreter 510 to be executed (S180).

The garbage collector unit 600 automatically collects the space occupied by the unused codes so as to secure more space in the first memory unit 200. In addition, if the first memory unit 200 lacks space even after the unused codes are processed, the native code manager unit 300 is requested to store the native codes, which have been loaded into the first memory unit 200, in the second memory unit 400, thereby securing more space in the first memory unit 200.

According to the present invention, relevant byte codes frequently used upon execution of a Java program are compiled and resultant native codes are stored so that the native codes for the relevant byte codes are retrieved and executed upon future execution of the Java program. Thus, there is an advantage in that the time required for generating the native codes by compiling the byte codes can be shortened.

Further, there are advantages in that the compiling time and the execution time of the Java program are shortened in equipment such as a cellular phone with a low-performance CPU and a low-capacity battery, thereby reducing response time to a user and conserving battery power.

The present invention has been described in connection with the illustrative, non-limiting embodiments thereof shown in the accompanying drawings and are mere examples of the present invention. It can also be understood by those skilled in the art that various changes and modifications thereof can be made thereto without departing from the scope and spirit of the present invention defined by the claims. Therefore, simple changes to the embodiments of the present invention fall within the scope of the present invention.

What is claimed is:

1. A system for shortening the compiling time of byte codes in a Java program, comprising:
a class loader unit for loading byte codes generated by compiling Java program source codes;
a first memory unit for maintaining the byte codes loaded by the class loader unit and native codes generated by compiling the byte codes in an accessible state;
a second memory unit for storing the native codes that are loaded into the first memory unit in the accessible state;
a native code manager unit for searching the native codes stored in the second memory unit and loading requested native codes into the first memory unit according to a request by a class loader unit; and
an execution unit for executing the native codes that are loaded into the first memory unit in the accessible state.

2. The system as claimed in claim 1, further comprising a garbage collector unit for automatically collecting space occupied by unused codes in the first memory unit.

3. The system as claimed in claim 2, wherein the garbage collector unit requests the native code manager unit to store the native codes, which have been loaded into the first memory unit, in the second memory unit if a space shortage occurs in the first memory unit.

4. The system as claimed in claim 1, wherein the native code manager unit stores the native codes, which have been loaded into the first memory unit, in the second memory unit.

5. The system as claimed in claim 1, wherein the native code manager unit employs an LRU (least recently used) method to manage the native codes stored in the second memory unit.

6. The system as claimed in claim 4, wherein the native code manager unit employs an LRU (least recently used) method to manage the native codes stored in the second memory unit.

7. The system as claimed in the claim 1, wherein the execution unit comprises:
a byte code interpreter for interpreting the byte codes, which are loaded into the first memory unit in the accessible state, to be executed;
a runtime profiler for checking whether the byte codes being interpreted by the byte code interpreter are frequently used byte codes; and
a native code compiler for compiling the checked byte codes to native codes if the checked byte codes are determined as the frequently used byte codes by the runtime profiler.

8. A method for shortening the compiling time of byte codes in a Java program, comprising the steps of:
(a1) loading compiled byte codes by a class loader unit;
(a2) requesting a native code manager unit to search native codes corresponding to the loaded byte codes;
(a3) searching for the requested native codes in a second memory unit;
(a4) transmitting the requested native codes to a first memory unit; and
(a5) executing the transmitted native codes by a code execution unit.

9. The method as claimed in claim 8, wherein the native codes stored in the second memory unit are managed by the native code manager unit according to an LRU (least recently used) method.

10. The method as claimed in claim 8, further comprising the steps of, if it is determined from the search results that there are no corresponding native codes in the second memory unit:
(a6) transmitting the byte codes loaded by the class loader unit to the first memory unit; and
(a7) interpreting and executing the byte codes transmitted to the first memory unit by a byte code interpreter.

11. The method as claimed in claim 10, wherein step (a7) comprises the step of checking, by a runtime profiler, whether the byte codes being interpreted by the byte code interpreter are frequently used byte codes.

12. The method as claimed in claim 11, further comprising the steps of, if the byte codes are identified as frequently used byte codes from the check results:
(a8) generating, by a native code compiler, native codes corresponding to the frequently used byte codes by compiling the byte codes interpreted by the byte code interpreter;
(a9) loading the generated native codes into the first memory unit; and
(a10) storing the loaded native codes in the second memory unit by the native code manager unit.

13. The method as claimed in claim 8, wherein the native codes loaded into the first memory unit are stored in the second memory unit if the execution of the Java program is terminated or a space shortage occurs in the first memory unit.

14. The method as claimed in claim 10, wherein the native codes stored in the second memory unit are managed by the native code manager unit according to an LRU (least recently used) method.

15. The method as claimed in claim 13, wherein the native codes stored in the second memory unit are managed by the native code manager unit according to an LRU (least recently used) method.
